(19) United States
(12) Patent Application Publication
(10) Pub. No.: US 2012/0051054 A1
(43) Pub. Date: Mar. 1, 2012

(54) SOLID STATE LUMINAIRE HAVING PRECISE AIMING AND THERMAL CONTROL

(75) Inventors: Rick Kauffman, Buford, GA (US); Donald Sipes, Colorado Springs, CO (US); Donald VanderSluis, Sarasota, FL (US); Robert Fugerer, Lutz, FL (US)

(73) Assignee: SUNOVIA ENERGY TECHNOLOGIES, INC., Sarasota, FL (US)

(21) Appl. No.: 13/318,070

(22) PCT Filed: Apr. 28, 2010
(86) PCT No.: PCT/US10/32827

§ 371 Date: Oct. 28, 2011

Related U.S. Application Data
(60) Provisional application No. 61/173,522, filed on Apr. 28, 2009.

(51) Int. Cl. F21V 21/00; F21V 29/00

(52) U.S. Cl. 362/249.02; 362/249.01

(57) ABSTRACT

A luminaire for re-use, a retro-fit device, or mechanism, that are designed to both fit into an existing luminaire while also making efficient use of LEDs or other solid state light elements is provided. Thermal elements are provided that act to remove heat generated by light elements. A housing is provided that may be configured to receive LEDs, or other optical elements, that are aimed to provide light in a desired direction through mounting to a facet or mounting surface, and have effective thermal environment control through one or more fins mounted to the side of the facet opposite the light element. Luminaires are provided for both original designs that utilize solid state light elements, and retrofit assemblies designed to convert an existing luminaire (that uses a traditional light source or sources) into a luminaire that uses solid state light elements.

### CROSS-REFERENCE TO RELATED APPLICATIONS

This application claims priority to U.S. Provisional Patent Application No. 61/173,522, filed on Apr. 28, 2009, the entire disclosure of which is incorporated herein by reference.

This application is also related to co-pending U.S. patent application Ser. No. 12/767,698, filed on Apr. 26, 2010, entitled “Solid State Lighting Unit Incorporating Optical Spreading Elements; U.S. patent application Ser. No. ______, filed on Apr. 28, 2010, entitled “Solid State Luminaire With Reduced Optical Losses,” and identified as Attorney Docket No. 51119.830011.US1; and U.S. patent application Ser. No. ______, filed on Apr. 28, 2010, entitled “Retrofit System For Converting An Existing Luminaire Into A Solid State Lighting Luminaire,” and identified as Attorney Docket No. 51119.830013.US1. The disclosures of each of these related applications are incorporated herein by reference.

### FIELD

The present disclosure relates to solid state lighting, and aiming and thermal control for point light sources used in solid state lighting to achieve desired illumination patterns.

### BACKGROUND

Lighting systems traditionally use various different types of illumination devices, commonly including incandescent lights, fluorescent lights, and Light Emitting Diode (LED) based lights. LED based lights generally rely on multiple diode elements to produce sufficient light for the needs for a particular application of the particular light or lighting system. As an approach to offset the ever increasing price of energy and make a meaningful indent to the production of greenhouse gases, LED lighting offers great promise in this regard. With efficacies approaching 150 lumens per Watt, and lifetimes at over 50,000 Hours, LEDs and lighting products based on LED technology may potentially make significant inroads in the lighting market in residential and commercial, indoor and outdoor applications.

LED based lights offer significant advantages in efficiency and longevity compared to, for example, incandescent sources, and produce less waste heat. For example, if an ideal solid-state lighting device were to be fabricated, the same level of luminance can be achieved by using merely 1/20 of the energy that an equivalent incandescent lighting source requires. LEDs offer greater life than many other lighting sources, such as incandescent lights and compact fluorescents, and contain no environmentally harmful mercury that is present in fluorescent type lights. LED based lights also offer the advantage of instant-on and are not degraded by repeated on-off cycling.

As mentioned above, LED based lights generally rely on multiple LED elements to generate light. An LED element, as is well known in the art, is a small area light source, often with associated optics that shape the radiation pattern and assist in reflection of the output of the LED. LEDs are often used as small indicator lights on electronic devices and increasingly in higher power applications such as flashlights and area lighting. The color of the emitted light depends on the composition and condition of the semiconducting material used to form the junction of the LED, and can be infrared, visible, or ultraviolet.

Within the visible spectrum, LEDs can be fabricated to produce desired colors. For applications where the LED is to be used in area lighting, a white light output is typically desirable. There are two common ways of producing high intensity white-light LED. One is to first produce individual LEDs that emit three primary colors (red, green, and blue), and then mix all the colors to produce white light. Such products are commonly referred to as multi-colored white LEDs, and sometimes referred to as RGB LEDs. Such multi-colored LEDs generally require sophisticated electro-optical design to control the blend and diffusion of different colors, and this approach has rarely been used to mass produce white LEDs in the industry to date. In principle, this mechanism has a relatively high quantum efficiency in producing white light.

A second method of producing white LED output is to fabricate a LED of one color, such as a blue LED made of InGaN, and coating the LED with a phosphor coating of a different color to produce white light. One common method to produce such and LED-based lighting element is to encapsulate InGaN blue LEDs inside of a phosphor coated epoxy. A common yellow phosphor material is cerium-doped yttrium aluminum garnet (Ce3+:YAG). Depending on the color of the original LED, phosphors of different colors can also be employed. LEDs fabricated using such techniques are generally referred to as phosphor based white LEDs. Although less costly to manufacture than multi-colored LEDs, phosphor based LEDs have a lower quantum efficiency relative to multi-colored LEDs. Phosphor based LEDs also have phosphor-related degradation issues, in which the output of the LED will degrade over time. Although the phosphor based white LEDs are relatively easier to manufacture, such LEDs are affected by Stokes energy loss, a loss that occurs when shorter wavelength photons (e.g., blue photons) are converted to longer wavelength photons (e.g. white photons). As such, it is often desirable to reduce the amount of phosphor used in such applications, to thereby reduce this energy loss. As a result, LED-based white lights that employ LED elements with such reduced phosphor commonly have a blue color when viewed by an observer.

Various other types of solid state lighting elements may also be used in various lighting applications. Quantum Dots, for example, are semiconductor nanocrystals that possess unique optical properties. The emission color of quantum dots can be tuned from the visible throughout the infrared spectrum. This allows quantum dot LEDs to create almost any output color. Organic light-emitting diodes (OLEDs) include an emitting layer material that is an organic compound. To function as a semiconductor, the organic emitting material must have conjugated pi bonds. The emitting material can be a small organic molecule in a crystalline phase, or a polymer. Polymer materials can be flexible; such LEDs are known as PLEDs or FLEDs.

In an ideal situation, luminaires may be designed to optimally incorporate LEDs and make full use of the various properties and advantages for the particular LED that is incorporated into the luminaire. However, in many cases it may be desirable to retrofit an existing light housing to incorporate a solid state light unit. For example, it may desired to preserve the housing of a luminaire for re-use so as to avoid the cost of completely replacing the entire light housing, which can have considerable cost.

### SUMMARY

The present disclosure provides embodiments of a luminaire for re-use, a retro-fit device, or mechanism, that are designed to both fit into an existing luminaire while also making efficient use of LEDs or other solid state light elements. Embodiments provide thermal elements that act to remove heat generated by light elements. A housing is provided, in some embodiments, that is configured to receive LEDs, or other optical elements, that are aimed to provide light in a desired direction through mounting to a facet, and have effective thermal environment control through one or more fins mounted to the side of the facet opposite the light element. Embodiments include both luminaires originally designed to utilize solid state light elements, or in retrofit assemblies designed to convert an existing luminaire that uses a traditional light source or sources into a luminaire that uses solid state light elements.

In one aspect, the present disclosure provides a lamp assembly, comprising: (a) a housing having a plurality of mounting surfaces, the plurality of mounting surfaces each comprising a generally planar surface on a first side and a heat dissipating element on a second side, the planar surfaces having a plurality of different angles relative planar surfaces of other of the plurality of mounting surfaces, and (b) at least one solid state light element mounted to the first side of each mounting surface, each of at least a subset of the plurality of light elements providing light output along a respective primary axis that intersects a centerline of the housing, the output of the plurality of solid state light elements combining to provide an output illumination pattern. One or more of the plurality of solid state light elements may comprise a collimating component that collimates light produced by the associated solid state light element. The solid state light elements may be light emitting diodes, and/or other types of solid state light elements. In one embodiment, the housing is adapted to be mounted in an outdoor street light, such as a cobra head street light.

The heat dissipating element may include a heat dissipating fin located on the second side of the mounting surface. Such a heat dissipating fin may include one or more apertures to secure the solid state light element to the first side of the mounting surface. In some embodiments, the heat dissipating fin provides additional structural support to the respective mounting surface.

In another embodiment, an array of solid state light elements are mounted to the first side of at least one of the plurality of mounting surfaces. Each solid state light element of the array of solid state light elements may provide light output along a primary axis that is substantially parallel to the primary axis of the other solid state light elements in the array.

In a further embodiment, the lamp assembly further comprises an external lens secured to the housing. The lamp assembly in other embodiments also comprises a power supply located on a top surface of said housing and electrically interconnected in power supplying communication with each of the solid state light elements.

In another aspect, the present disclosure provides a lamp assembly, comprising: (a) a housing adapted to be mounted in a street light fixture and comprising a plurality of mounting surfaces that each have a first side and a second side; (b) a plurality of heat dissipation elements located on the second sides of the mounting surfaces; and (c) a plurality of solid state light elements mounted to the first sides of the mounting surfaces, each of the plurality of light elements providing light output along a respective primary axis that is substantially orthogonal to a respective plane of the first side, the output of the plurality of solid state light elements combining to provide an output illumination pattern. The heat dissipating element may comprise a heat dissipating fin located on the second side of the mounting surface. The heat dissipating fin may comprise one or more apertures to secure the solid state light element to the first side of the mounting surface. The heat dissipating fin may also provide additional structural support to the respective mounting surface. In some embodiments, an array of solid state light elements are mounted to the first side of at least one of the plurality of mounting surfaces. Each solid state light element of such an array of solid state light elements may provide light output along a primary axis that is substantially parallel to the primary axis of the other solid state light elements in the array.

### BRIEF DESCRIPTION OF THE DRAWINGS

FIG. 1 is a bottom perspective view of a solid state lighting assembly of an exemplary aspect of the disclosure;

FIG. 2 is a bottom perspective view of a housing of a solid state lighting assembly of an exemplary aspect of the disclosure;

FIG. 3 is a side elevation view of a solid state lighting assembly of an exemplary aspect of the disclosure;

FIG. 4 is a cross-sectional illustration of the solid state lighting assembly of FIG. 3;

FIG. 5 is an illustration of a secondary optic of various embodiments; and

FIG. 6 is a bottom perspective view of the faceted lens for use with a solid state lighting assembly of an exemplary aspect of the disclosure.

### DETAILED DESCRIPTION

The present disclosure recognizes that typical traditional lighting sources such as incandescent, metal halide and sodium vapor lamps normally operate at much higher temperatures than LEDs where as LEDs need to maintain much more modest temperatures for longevity. Also, while proper placement of the traditional emitter within its reflector is critical to achieving the desired light pattern, LEDs must be precisely aimed on an individual or small array basis to efficiently achieve the desired light pattern. Throughout this disclosure reference will be made to LEDs with the understanding that concepts described herein may be applied to other types of solid state light elements, such as those described above.

Embodiments described herein provide a LED luminaire or luminaire retrofit device designed such that the light produced by the LEDs is precisely directed by aiming the LEDs themselves (and/or their secondary collimating optics, if present) to the area that is desired to be illuminated by the particular LED, and focusing LED output as needed via spreading and/or steering lenses to achieve the desired pattern of foot-candles on the ground or other surface that is to be illuminated by the luminaire.

When attempting to retrofit an existing device, several properties related to LEDs present challenges to implementing a suitable design that accomplishes an equivalent, or better, lighting output for the housing with the originally designed light source. For example, the output from LEDs is much more directional than the output of an incandescent light or a gas discharge light, for example. Considerations related to providing adequate light from the luminaire over the entire area that is to be lighted also must be included in any design. In this regard, LED output can be efficiently utilized when the optical system of the luminaire is designed to place the correct amount of light precisely where it is desired. This may require controlled collimation of the LEDs' output, correct aiming of that collimated beam of light, and in typical applications, some of those beams need to be spread over a greater of lesser areas than other beams. Present implementations may spread those LED beams using a spreading lens attached to a collimating lens or incorporated into the collimating lens.

As is also well understood, LEDs often are mounted to devices that work to transfer heat generated by the LED away from the LED, thereby enhancing the operation of the semiconductor junction of the LED as well as enhancing the operational lifetime of the LED. Various exemplary embodiments described herein provide thermal management for the LED light sources, as well as mounting surfaces for efficient mounting and aiming of individual LEDs, or arrays of LEDs. Common thermal management techniques provide heat sinks for LEDs, such as heat sinking provided by simple finned flat-plate style heat sinks, typically extruded aluminum. Such a configuration may provide sufficient heat sinking, if all or most of the LEDs are mounted to one finned flat plate. However, in applications in which a relatively large number of LEDs are mounted to one finned flat plate, the LED devices cannot all be optimally aimed such that the light output of the collection of LEDs provide the desired pattern of light on the ground.

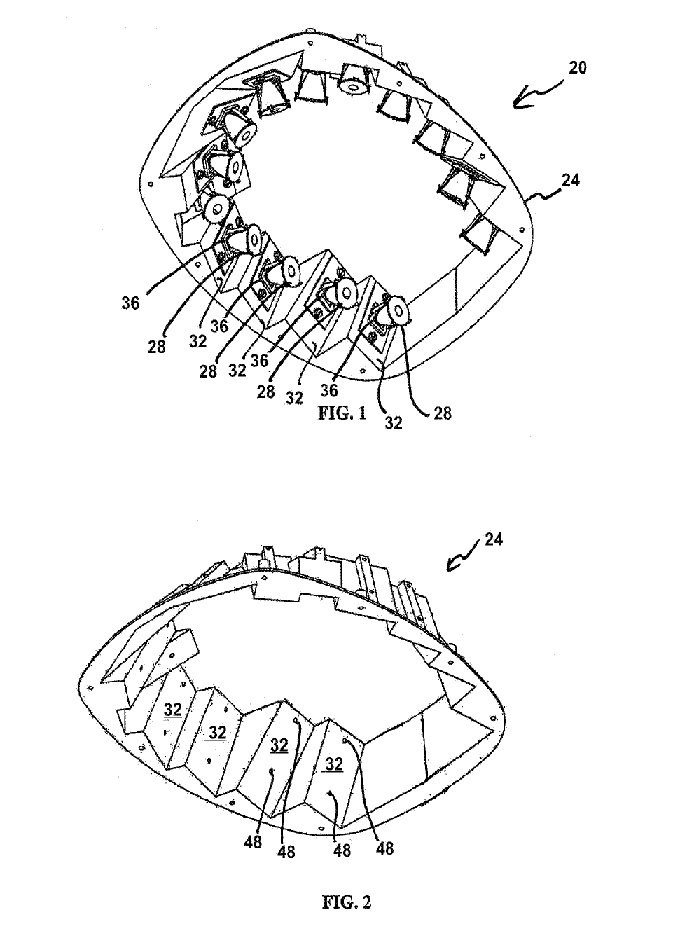

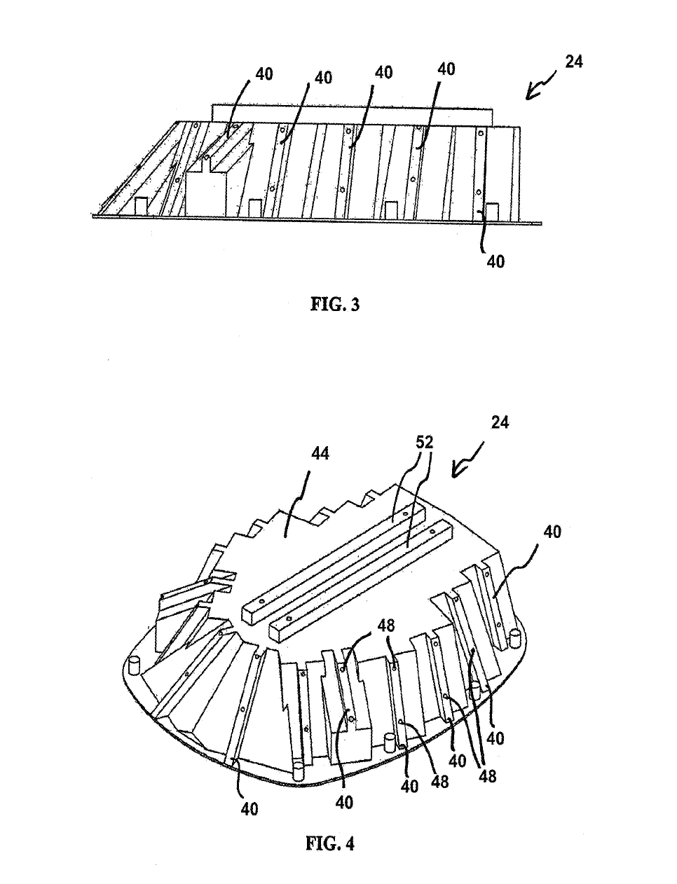

To adequately address both issues of aiming and thermal management, an exemplary embodiment, illustrated in FIGS. 1-4, combines both aiming and thermal management functions into a single platform. Such an embodiment provides both enhanced aiming of the LEDs while also providing sufficient thermal management to keep the LEDs sufficiently cool so as to achieve efficient operation of the LEDs over a long lifetime. The light assembly of FIGS. 1-4 is configured for use in street lighting applications, and this particular embodiment is directed to a light assembly for use in a “cobra head” street lighting fixture. The light assembly of the embodiment of FIGS. 1-4 may be used in either a new installation or a street light, or in a retro-fit of an existing street light assembly.

As illustrated in FIGS. 1-4, an LED-based lighting assembly 20 includes a housing 24 that functions as an aiming platform for a plurality of separate light sources 28. The housing 24 of this embodiment is a single piece with multiple inside facets 32, also referred to as mounting surfaces. The light sources 28, in this embodiment, include LEDs that are mounted to thermally conductive printed circuit boards (PCBs) 36 which in turn are mounted to the inside facets 32 of the aiming platform of the housing 24. Each facet 32 is oriented so as to be orthogonal to the primary aiming axis or vector of each light source 28, such as a LED and its associated secondary optic. The PCBs 36 may be mounted to the associated mounting surface or facet 32 using one or more of a thermally conductive adhesive, screws, and rivets, for example.

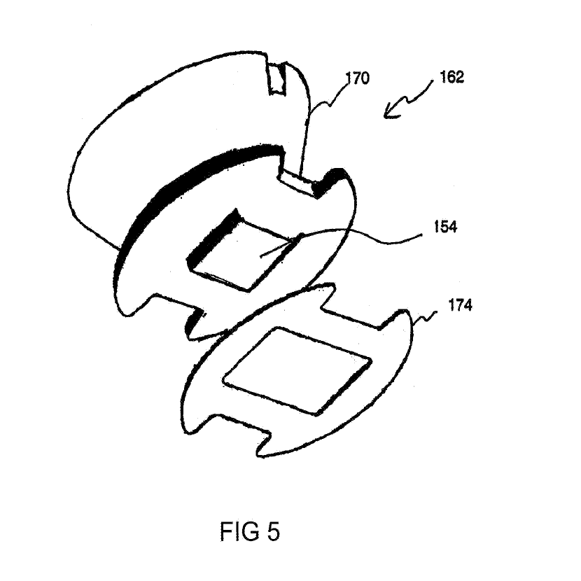

Incorporated into the outside of each facet 32, as is best seen in FIGS. 3 and 4, is a fin 40 that facilitates dissipation of the heat generated by the light sources 28. This heat dissipation may occur through convection, radiation and/or conduction. While illustrated as a single fin 40 in this embodiment, it will be understood that such a heat dissipation element may take on any of a number of different configurations. In some embodiments, the fin 40 is configures to provide additional structural support to the associated facet 32. In some embodiments, light sources 28 utilize a multiplicity of LED packages that each contain a single LED die or multiple die, or a multiplicity of small arrays of LEDs with all the LEDs in a given small array being aimed in the same direction. In further embodiments, arrays of LEDs are provided with different LEDs in the array having associated secondary optics, and are aimed in slightly different directions.

Such an arrangement of LED light elements and secondary optics provides a desired pattern of light, where individual spreading lenses are properly selected and attached to each collimating lens, or each collimating lens incorporates a different degree of beam spread and is selected to create the required light pattern. This method provides an accurate, optically effective light pattern, and provides a great deal of flexibility to address the potential need for producing various patterns. Such an implementation of aimed LEDs means that each LED, small array of LEDs, or group of LEDs, will be aimed in a direction different from nearby LEDs, arrays of LEDs, or groups of LEDs. The rays of light from each light source(s) consequently travels in a direction different from those of nearby light sources.

Each light source 28, in this embodiment, is mounted to a mounting surface or facet 32. The mounting surfaces 32 are fabricated into the housing 24 at different angles relative to one another and light sources 28 are mounted to the mounting surfaces 32 such that the primary axis of light output of the light source 28 is substantially orthogonal to the respective facet 32. The different facets 32 and the angles of these facets 32 are designed to provide the output of the associated light sources 28 at different parts of the area to be illuminated, and thereby provide the desired light output pattern from the luminaire. As mentioned above, in some embodiments, some or all of the light sources 28 may include an array of LED sources and secondary optics, such as an array of three or five light sources 28 mounted to a common substrate, such as a printed circuit board, that is mounted to the respective mounting surface 32. In such embodiments, the primary axis of light output of each of the light sources 28 in the array may be in substantially the same direction, or may be in slightly different directions, to provide light output at a certain intensity over an area to be illuminated by those particular light sources. In still further embodiments, the housing 24 includes fewer facets 32 with light sources 28 mounted and aimed in different directions to provide the desired light output pattern. In these embodiments, the primary axis of light output from the light sources 28 may not be orthogonal to the mounting surface, instead being aimed in the appropriate direction using secondary optics or through shims or wedges installed between the light source and facet 32.

In the exemplary embodiment of FIGS. 1-4, fins 40 also provide material for fasteners to securely mount the PCB 36 to the facet 32 in the inside of the housing 24. Mounting holes 48 formed through the fins 40 and facets 32 are used to secure the printed circuit boards 36 to the housing 24. The housing 24 also includes a mounting assembly 52 to which a power supply may be mounted. Electronic connections between the printed circuit boards 36 and the power supply may be accomplished through wired connections through one of the mounting holes 48, or through a separate aperture through the top of the housing 24. The power supply may be any suitable power supply as are well understood by those of skill in the art. The power supply receives incoming AC power from an AC power source and converts this power in to DC power that is used to power the solid state lighting elements that are included in the housing 24. Alternatively, the power supply may receive DC power from a DC power source and provide operating power to the solid state lighting elements that are included in the housing 24. In some embodiments, power supply may be adjustable so as to provide differing power outputs based on the amount of light needed to be output from the lamp assembly.

The housing 24, in one embodiment, is constructed of a material with relatively high thermal conductivity, such as aluminum or aluminum alloy. Other thermally conductive materials which may be used include but are not limited to, steel, copper, zinc and related alloys, and thermally conductive polymers and polymer alloys. The housing 24 may be constructed in any of a number of manners, including casting, molding, forming, machining, wire EDM, laser cutting and/or ablation, to name a few. In some embodiments, The topside outer surface 44 of housing 24 may be coated and/or textured so as to be able to reflect radiant energy from external sources such as the outer housing of a luminaire heated by the solar radiation from the sun. The treatment to the outer surface of the housing 24 may be selected to be as radiative as possible to help remove heat from the platform. The coating may also enhance resistance to corrosion. Texturing the outer surface 44 of the housing 24 may be accomplished by, for example, molding, casting, laser cutting and/or ablation, sand blasting, bead blasting or chemical etching. The outer surface 44 may be coated by, for example, painting, powder coating, anodizing, hot dipping and/or chemical etching. The inner faceted surfaces 32 may also be anodized or treated with one or several coatings as above to enhance thermal performance and/or increase resistance to corrosion.

As discussed above, an LED light element may include a secondary optic element that provides collimation or other beam shaping to the light output from the LED. With reference now to FIG. 5, an illustration a collimating optic component 162 that is used as a secondary optic in one embodiment is discussed. The collimating optic 162 includes lens portion 170 that is adapted to receive an LED light element through aperture 154. The lens 170 is mounted to a substrate using an adhesive pad 174, in this embodiment. In some embodiments, frensel type lenses may be attached to the lens 170 to further shape the light output. As mentioned above, the secondary optic component, in combination with optical spreading and/or steering elements of other light elements, can be used to achieve a desired output by using an appropriate combination of uncollimated, narrowly collimated, wide angle and/or oval projection LED beam patterns. As will be readily understood by one of skill in the art, other types of secondary optics may be used depending upon the desired output beam of a particular light element.

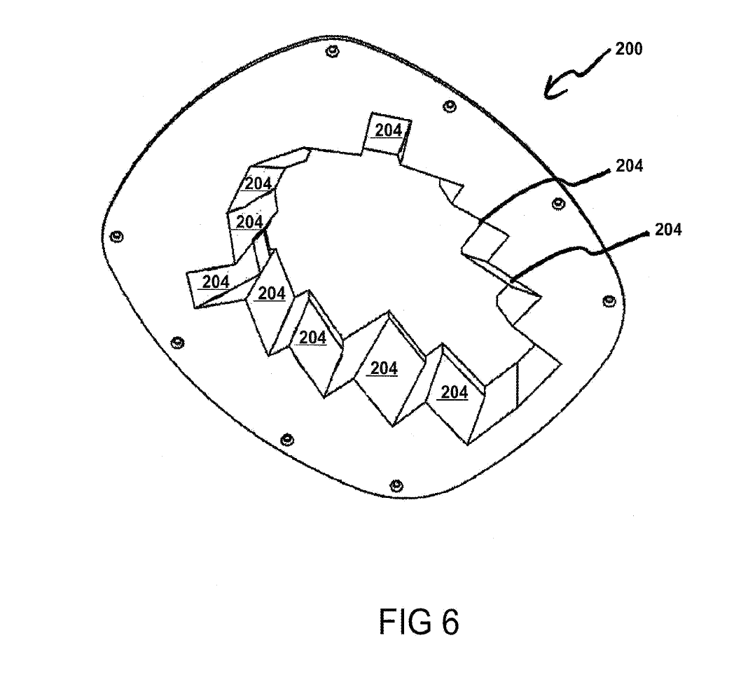

In various embodiments, an external lens may be secured to the housing 24 to provide protection to the light elements of the lighting assembly. An illustration of an external lens on an embodiment is provided in FIG. 6. In this embodiment, lens 200 may be secured to the bottom surface of housing 24. Lens 200, in this embodiment, includes a number of facets 204 that each correspond to facets 32 of the housing 24. Each facet 204 in this embodiment is oriented so as to be substantially orthogonal to the primary aiming axis or vector of an associated light source 28. On some embodiments, one or more of the facets 204 of the external lens 200 may include a separate lens that may be used to further steer or otherwise modify the light output from the associated light source 28.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A lamp assembly, comprising:
a housing having a plurality of mounting surfaces, the plurality of mounting surfaces each comprising a generally planar surface on a first side and a heat dissipating element on a second side, the planar surfaces having a plurality of different angles relative planar surfaces of other of the plurality of mounting surfaces, and
at least one solid state light element mounted to the first side of each mounting surface, each of at least a subset of the plurality of light elements providing light output along a respective primary axis that intersects a centerline of the housing, the output of the plurality of solid state light elements combining to provide an output illumination pattern.

2. The lamp assembly of claim 1, wherein at least one of the plurality of solid state light elements comprise a collimating component that collimates light produced by the associated solid state light element.

3. The lamp assembly of claim 1, wherein the solid state light elements are light emitting diodes.

4. The lamp assembly of claim 1, wherein the housing is adapted to be mounted in an outdoor street light.

5. The lamp assembly of claim 4, wherein the outdoor street light is a cobra head street light.

6. The lamp assembly of claim 1, wherein the heat dissipating element comprises a heat dissipating fin located on the second side of the mounting surface.

7. The lamp assembly of claim 6, wherein the heat dissipating fin comprises one or more apertures to secure the solid state light element to the first side of the mounting surface.

8. The lamp assembly of claim 6, wherein the heat dissipating fin provides additional structural support to the respective mounting surface.

9. The lamp assembly of claim 1, wherein an array of solid state light elements are mounted to the first side of at least one of the plurality of mounting surfaces.

10. The lamp assembly of claim 9, wherein each solid state light element of the array of solid state light elements provides light output along a primary axis that is substantially parallel to the primary axis of the other solid state light elements in the array.

11. The lamp assembly of claim 1, further comprising an external lens secured to the housing.

12. The lamp assembly of claim 1, further comprising a power supply located on a top surface of said housing and electrically interconnected in power supplying communication with each of the solid state light elements.

13. A lamp assembly, comprising:
a housing adapted to be mounted in a street light fixture and comprising a plurality of mounting surfaces that each have a first side and a second side;
a plurality of heat dissipation elements located on said second sides of said mounting surfaces; and
a plurality of solid state light elements mounted to said first sides of said mounting surfaces, each said plurality of light elements providing light output along a respective primary axis that is substantially orthogonal to a respective plane of said first side, the output of the plurality of solid state light elements combining to provide an output illumination pattern.

14. The lamp assembly of claim 13, wherein at least one of the plurality of solid state light elements comprise a collimating component that collimates light produced by the associated solid state light element.

15. The lamp assembly of claim 13, wherein the street light fixture is a cobra head street light.

16. The lamp assembly of claim 13, wherein the heat dissipating element comprises a heat dissipating fin located on the second side of the mounting surface.

17. The lamp assembly of claim 16, wherein the heat dissipating fin comprises one or more apertures to secure the solid state light element to the first side of the mounting surface.

18. The lamp assembly of claim 16, wherein the heat dissipating fin provides additional structural support to the respective mounting surface.

19. The lamp assembly of claim 13, wherein an array of solid state light elements are mounted to the first side of at least one of the plurality of mounting surfaces.

20. The lamp assembly of claim 19, wherein each solid state light element of the array of solid state light elements provides light output along a primary axis that is substantially parallel to the primary axis of the other solid state light elements in the array.
